(19) United States
(12) Patent Application Publication
(10) Pub. No.: US 2008/0243470 A1
(43) Pub. Date: Oct. 2, 2008

(54) LOGICAL CHECK ASSIST PROGRAM, RECORDING MEDIUM ON WHICH THE PROGRAM IS RECORDED, LOGICAL CHECK ASSIST APPARATUS, AND LOGICAL CHECK ASSIST METHOD

(75) Inventor: Hiroaki IWASHITA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawaskai (JP)

(21) Appl. No.: 12/023,583

(22) Filed: Jan. 31, 2008

(30) Foreign Application Priority Data
Mar. 29, 2007 (JP) 2007-089143

(51) Int. Cl. G06F 9/455

(52) U.S. Cl. 703/27

(57) ABSTRACT

A computer-readable medium stores a program which, when executed by a computer, causes the computer to execute functions including an extraction operation of extracting a sequence of character strings that are arranged in order of transitions and indicate meanings of transition conditions of transition branches that are taken to reach each transition state starting from an initial state from a finite state machine model of a hardware module which is a check subject; a generation operation of generating message information which means transitions that are taken to reach each transition state starting from the initial state by burying the sequence of character strings extracted by the extraction operation at a burying position for a partial character string which is part of a character string indicating each state of the finite state machine model; and an output operation of outputting the message information generated by the generation operation.

### BACKGROUND

The embodiment relates to a logical check assist program for assisting a logical check on a check subject such as an LSI hardware module, a recording medium on which the program is recorded, and a related logical check assist apparatus and method.

### SUMMARY

According to an aspect of an embodiment, a computer-readable medium stores a program which, when executed by a computer, causes the computer to execute functions including an extraction operation of extracting a sequence of character strings that are arranged in order of transitions and indicate meanings of transition conditions of transition branches that are taken to reach each transition state starting from an initial state from a finite state machine model of a hardware module which is a check subject; a generation operation of generating message information which means transitions that are taken to reach each transition state starting from the initial state by burying the sequence of character strings extracted by the extraction operation at a burying position for a partial character string which is part of a character string indicating each state of the finite state machine model; and an output operation of outputting the message information generated by the generation operation.

The above-described embodiments of the present invention are intended as examples, and all embodiments of the present invention are not limited to including the features described above.

### BRIEF DESCRIPTION OF THE DRAWINGS

FIG. 1 illustrates the hardware configuration of a logical check assist apparatus according to an embodiment of the present invention;

FIG. 2 is a block diagram showing the functional configuration of the logical check assist apparatus according to the embodiment of the invention;

FIG. 3 illustrates interface specification description information D1 of a hardware module M;

FIG. 4 is a state transition graph of the hardware module M;

FIG. 5 illustrates specific examples of state transition algorithms;

FIGS. 6-8 illustrate a procedure for generating the state transition graph of FIG. 4;

FIG. 9 illustrates an exemplary message template;

FIG. 10 illustrates a specific example of an output form;

FIG. 11 illustrates a state transition table of the hardware module M;

FIG. 12 illustrates the outline of a constraint logical expression conversion process;

FIG. 13 illustrates a variable list Rt of state S1;

FIG. 14 illustrates an exemplary assertion template;

FIG. 15 illustrates assertion description information D2 of the hardware module M;

FIG. 16 illustrates a specific example of an interface protocol checker HDL;

FIG. 17 is a flowchart showing a logical check assist process of the logical check assist apparatus according to the embodiment of the invention;

FIG. 18 is a flowchart of a message information generation process;

FIG. 19 is a flowchart of an assertion description information generation process; and

FIG. 20 illustrates a problem of a logical check on a hardware module using an interface protocol checker.

### DETAILED DESCRIPTION OF THE PREFERRED EMBODIMENTS

Reference may now be made in detail to embodiments of the present invention, examples of which are illustrated in the accompanying drawings, wherein like reference numerals refer to like elements throughout.

Conventionally, when designing hardware modules, such as large-scale integration (LSI) hardware modules, increasing the work efficiency by shortening the design period is required. Checking whether a hardware module operates correctly, on the other hand, is indispensable. In particular, in hardware modules that are required to be increased or enhanced in scale, functionality, and operation speed, and reduced in power consumption, checking the work that was done is important in maintaining high quality.

A logical check on a hardware module can be performed by using an interface protocol checker for detecting a protocol violation. The interface protocol checker is automatically generated on the basis of an interface specification description.

For example, in a check environment in which a hardware module being checked is surrounded by a test bench, occurrence/non-occurrence of a protocol violation (non-satisfaction of a constraint) can be checked by monitoring whether or not input/output signal conversions (interface protocols) of the hardware module satisfy the specification.

However, in the hardware module logical check using such an automatically generated interface protocol checker, no reference is made to error messages that are output upon occurrence of protocol violations or that are difficult for the designer to understand.

As a result, work of determining (when and) where in the hardware module a protocol violation occurred, and what interface signal caused the protocol violation, takes enormous time, resulting in a problem that the check work and hence the design work takes an unduly long time.

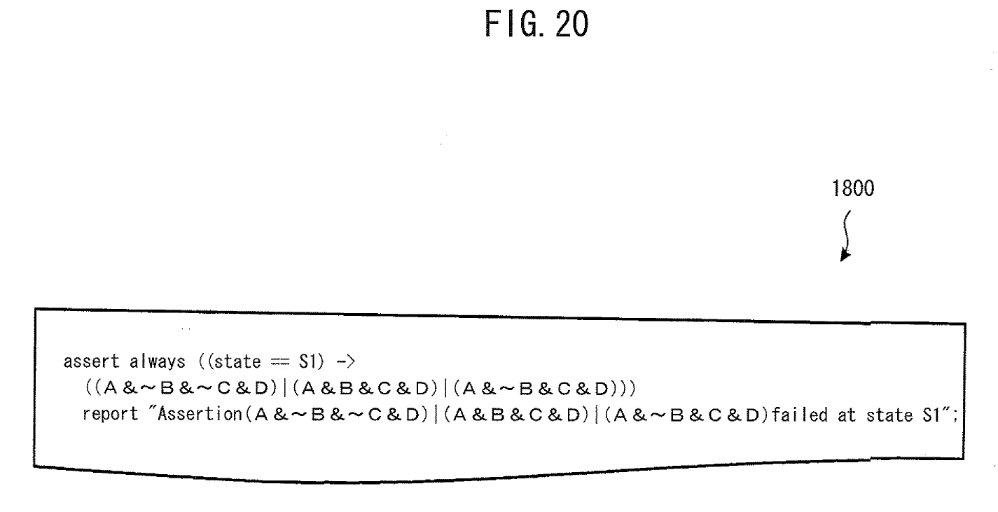

FIG. 20 illustrates this program in a specific manner. In FIG. 20, assertion description information 1800 is information to be used for executing an assertion for checking a protocol violation of a hardware module. When a protocol violation has occurred, the message written after the word “report” in the assertion description information 1800 is output.

In this example, if a protocol violation relating to state S1 that the hardware module can take occurs, a message “Assertion (A&˜B&˜C&D)|(A&B&C&D)|(A&˜B&C&D) failed at state S1” is output.

The designer determines a location of an occurrence of the protocol violation on the basis of this error message, and further determines an interface signal that has caused the protocol violation on the basis of the logical expression in the message. However, in practice, the determination work is very difficult because the number of interface signals is so large as to be expressed in 10 to 100 bits, resulting in a problem that the check work and hence the design work takes an unduly long time.

It is conceivable to generate an interface protocol checker manually and modify it so that it outputs error messages that the designer can understand easily. However, since the number of signals will be so large as to be expressed in 10 to 100 bits, the work of generating an interface protocol checker will take much time and labor, resulting in a problem that the check work will take an unduly long time.

A logical check assist program, a recording medium on which the program is recorded, a logical check assist apparatus, and a logical check assist method according to a preferred embodiment of the present invention will be hereinafter described in detail with reference to the accompanying drawings.

(Hardware Configuration of Logical Check Assist Apparatus)

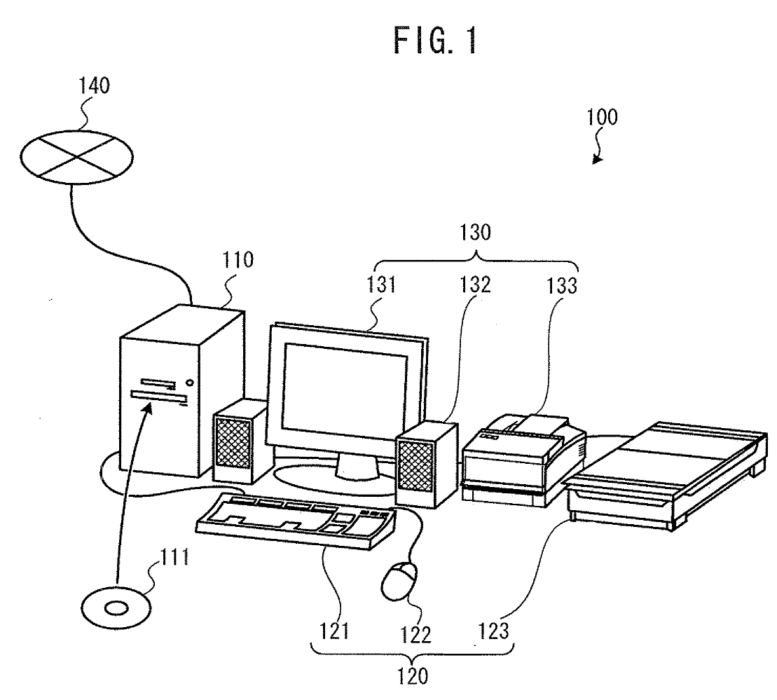

FIG. 1 illustrates a hardware configuration of a logical check assist apparatus 100 according to the embodiment of the invention. As shown in FIG. 1, the logical check assist apparatus 100 is composed of a computer main body 110, input devices 120, and output devices 130 and can be connected to a network 140 such as a LAN, WAN, or the Internet via a router or a modem (not shown).

The computer main body 110 has a CPU, memories, and interfaces. The CPU controls the entire hardware configuration of the logical check assist apparatus 100. The memories are a ROM, a RAM, an HD, an optical disc 111, and a flash memory and are used as work areas of the CPU.

Various programs are stored in the memories and loaded in response to a command from the CPU. Data writing and reading to and from the HD and the optical disc 111 are controlled by disc drives. The optical disc 111 and the flash memory are detachable from the computer main body 110. The interfaces control input from the input devices 120, output to the output devices 130, and data exchange with the network 140.

The input devices 120 are a keyboard 121, a mouse 122, a scanner 123, etc. The keyboard 121 has keys for input of characters, numerals, various instructions, etc. and serves for data input. The keyboard 121 may be of a touch panel type. The mouse 122 is used for moving a cursor, setting a range, moving a window, changing a window size, and performing other manipulations. The scanner 123 reads an image optically. An image read is taken in as image data and stored in a memory of the computer main body 110. The scanner 123 may be given an OCR function.

The output devices 130 are a display 131, speakers 132, a printer 133, etc. The display 131 displays a cursor, icons, tool boxes, and data of a document, an image, function information, etc. The speakers 132 output a sound such as an effect sound and a reading sound. The printer 133 prints image data and document data.

(Functional Configuration of Logical Check Assist Apparatus 100)

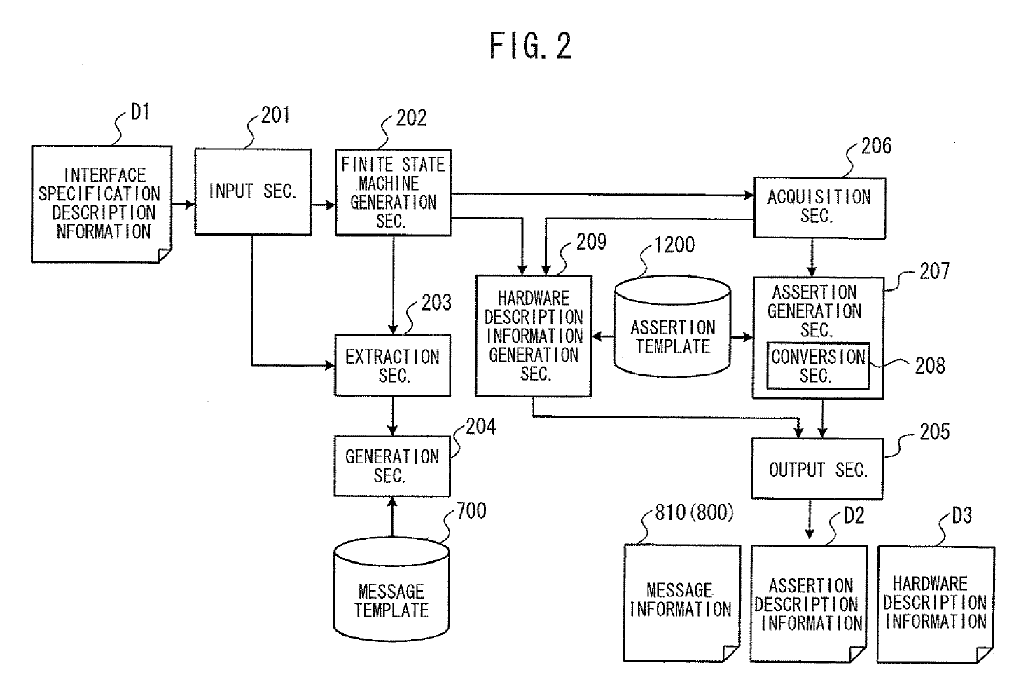

FIG. 2 is a block diagram showing the functional configuration of the logical check assist apparatus 100 according to the embodiment of the invention. As shown in FIG. 2, the logical check assist apparatus 100 is composed of an input section 201, a finite state machine generation section 202, an extraction section 203, a generation section 204, an output section 205, an acquisition section 206, an assertion generation section 207, a conversion section 208, and a hardware description information generation section 209.

The functions 201-209 can be realized by causing the CPU to run programs relating to them which are stored in the memories. Output data of the functions 201-209 are stored in the memories. Each function block as a destination of a connection indicated by each arrow in FIG. 2 causes the CPU to run a program relating to its function by reading, from a memory, output data of the connection source function block.

First, the input section 201 has a function of accepting input of interface specification description information D1 relating to a communication procedure of a hardware module M. The interface specification description information D1 is description information relating to a communication procedure of the hardware module M. The interface specification description information D1 whose input has been accepted by the input section 201 is stored in the memory.

More specifically, for example, the interface specification description information D1 describes, in an all-inclusive manner, what signals are input to the hardware module M, what kinds of communication are performed, and what signal variation patterns the respective kinds of communication have.

The interface specification description information D1 can be described as a text file on a computer and is described by using a description language in which grammar and interpretations are defined mathematically. For example, a signal value temporal variation pattern can be expressed mathematically by using a regular expression or the like as a base.

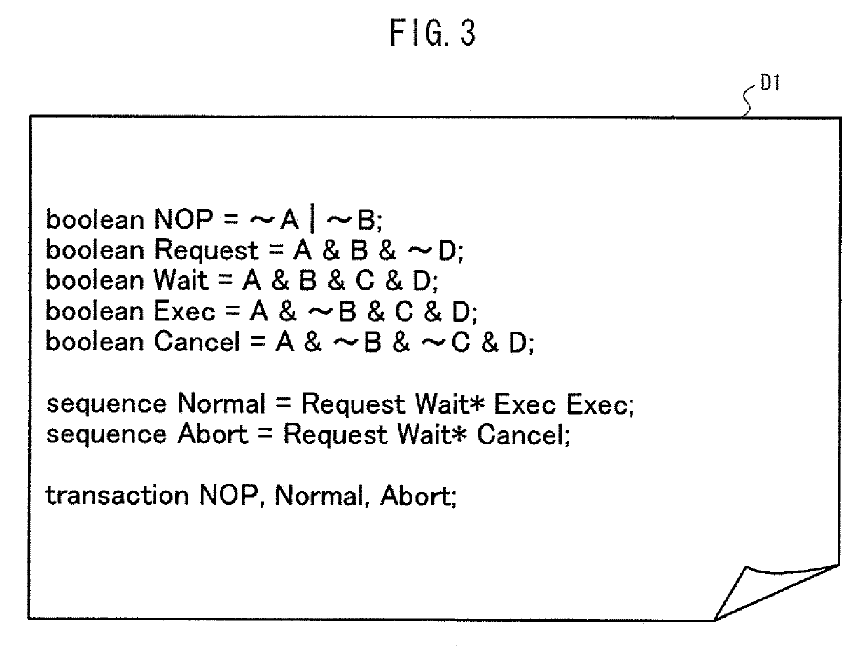

The interface specification description information D1 of the hardware module M will be described below. FIG. 3 illustrates the interface specification description information D1 of the hardware module M. In FIG. 3, symbols A, B, C, and D denote interface signals to be observed. Symbol “˜” denotes NOT, “|” denotes OR, “&” denotes AND, and “*” denotes repetition of zero or more times.

In FIG. 3, “Boolean” defines an input condition for signals that are input to the hardware module M. More specifically, it defines an input condition in the form of a combination of a character string indicating a meaning of the input condition and a logical expression that prescribes the input condition.

In this example, signal input conditions are defined by a combination of a character string “NOP” and a logical expression “˜A|˜B,” a combination of a character string “Request” and a logical expression “A&B&˜D,” a combination of a character string “Wait” and a logical expression “A&B&C&D,” a combination of a character string “Exec” and a logical expression “A&˜B&C&D,” and a combination of a character string “Cancel” and a logical expression “A&˜B&˜C&D,” respectively.

In FIG. 3, “sequence” defines a signal variation pattern of signals that are input to the hardware module M. More specifically, it defines a signal variation pattern in the form of a combination of a character string indicating a meaning of the signal variation pattern and a sequence of character strings each of which is defined by “Boolean.”

In this example, signal variation patterns are defined by a combination of a character string “Normal” and a sequence of character strings “Request Wait* Exec Exec” and a combination of a character string “Abort” and a sequence of character strings “Request Wait* Cancel,” respectively. In the case of “Abort,” for example, the sequence of character strings means that “Request” occurs first, then “Wait” is repeated zero or more times, and “Cancel” occurs thereafter.

In FIG. 3, “transaction” defines a variation of state sets that the hardware module M can take. More specifically, a variation is defined by character strings indicating state sets that the hardware module M can take. In this example, three state sets are defined by “NOP,” “Normal,” and “Abort.”

Returning to FIG. 2, the finite state machine generation section 202 has a function of generating a finite state machine model relating to state transitions of signals that are input to and output from the hardware module M on the basis of the interface specification description information D1 which has been input through the input section 201. More specifically, the finite state machine generation section 202 reads, from the memory, the interface specification description information D1 which has been input through the input section 201, generates a finite state machine model on the basis of the interface specification description information D1, and stores it in the memory.

The finite state machine model is an operation (dynamic) model which is described by using a set of finite states that the hardware module M can take and sets of finite transitions each of which is a set of possible transitions from one state to other states. The finite state machine model can be expressed as a state transition graph in which a sequence of character strings (label L (described later)) in which character strings indicating the meanings of signal input conditions are arranged according to a signal variation pattern is correlated with each transition state.

The sequence of character strings that is correlated with each transition state is a sequence of words indicating the meanings of input conditions, such as “NOP” and “Request” shown in FIG. 3. Each character string that is correlated with a transition state may be a symbol, a pictorial character, a figure, or the like that indicates the meaning of an input condition.

The finite state machine model can be expressed as a state transition graph in which a logical expression that prescribes a transition condition of a transition from an arbitrary transition source state to a corresponding transition destination state using input variables for describing an input condition is correlated with each transition branch. The input variables mean signal values of interface signals A, B, C, and D that are input to the hardware module M. A state transition graph 400 that is based on the interface specification description information D1 will be described below.

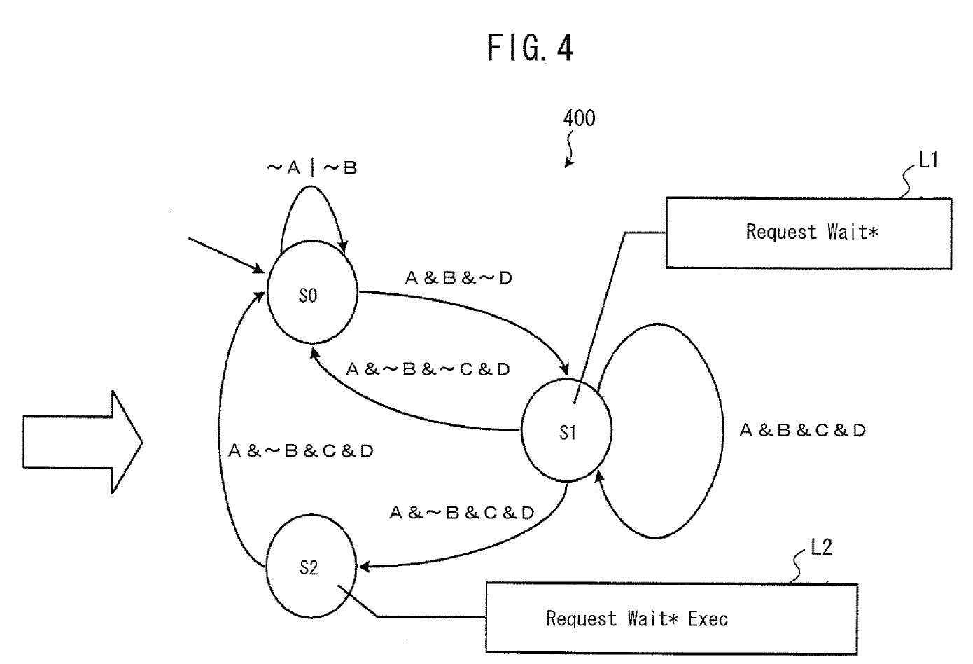

FIG. 4 illustrates a state transition graph 400 of the hardware module M. As shown in FIG. 4, the state transition graph 400 is a graph in which a logical expression (an input condition shown in FIG. 3) indicating a transition condition of a transition from an arbitrary transition source state to a corresponding transition destination state is correlated with each transition branch (S0→S0, S0→S1, S1→S0, S1→S1, S1→S2, or S2→S0).

In the state transition graph 400, state S0 is an initial state and a state transition occurs from a certain state to another state in synchronism with a clock. Each transition branch is associated with a logical expression indicating a transition condition. Since each logical expression is described by using a logical expression that is defined by “Boolean” (see FIG. 3), the logical expression itself is an input condition that signals that are input to the hardware module M should satisfy.

Each transition state (excluding the initial state) of the state transition graph 400 is correlated with a label L1 or L2 in which a message for identification of the state is written. A sequence of character strings obtained by arranging, in order of transitions, character strings indicating the meanings of logical expressions that are correlated with transition branches that should be followed to reach the associated transition state starting from the initial state are written in each of the labels L1 and L2.

More specifically, the sequence of character strings written in each of the labels L1 and L2 is a sequence of character strings obtained by arranging character strings indicating the meanings of signal input conditions according to a signal variation pattern. Based on the message written in the label L1 or L2, the designer can identify the associated transition state and recognize, by intuition, how to reach the associated transition state.

For example, a sequence of character strings “Request Wait*” which means transitions to be made to reach state S1 starting from state S0 is written in the label L1. The sequence of character strings “Request Wait*” means that state S1 is reached by repeating “Wait” zero or more times after occurrence of “Request.”

The message written in each of the labels L1 and L2 is only required to have information that enables identification of the associated state and to be expressed in such a manner as to allow the designer to understand it easily. For example, an ID for identification of the associated transition state may be written in each of the labels L1 and L2.

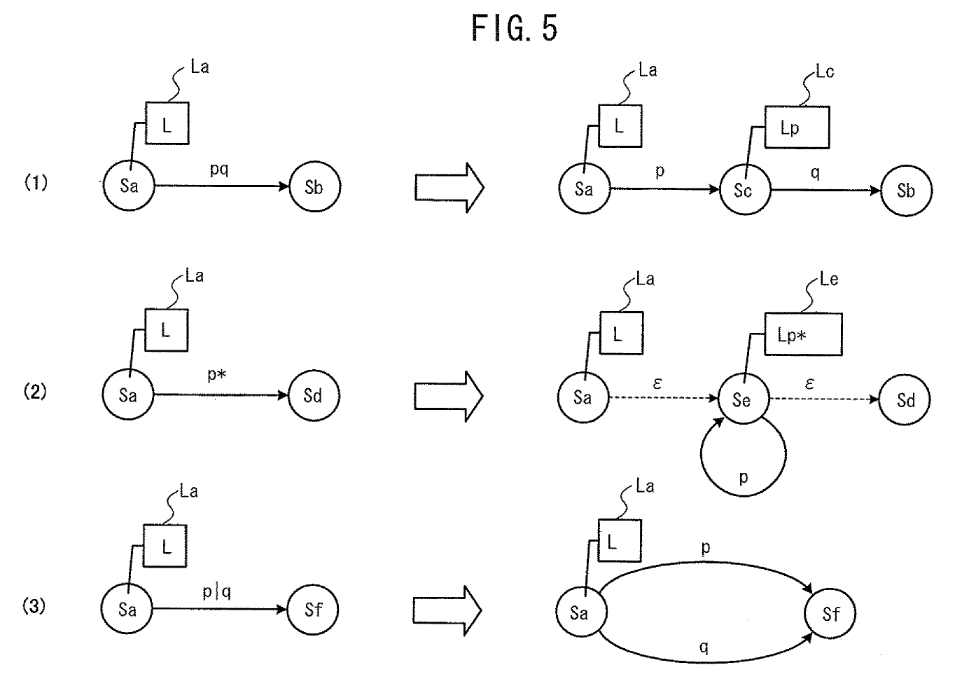

An exemplary technique by which the finite state machine generation section 202 generates the state transition graph 400 will be described below. First, state transition algorithms will be described. FIG. 5 illustrates specific examples of state transition algorithms. In FIG. 5, characters “p” and “q” are regular expressions representing transition conditions and “ε” denotes an epsilon transition.

In item (1) of FIG. 5, the transition branch between states Sa and Sb is correlated with a regular expression “pq” which represents a transition condition. Develop the regular expression “pq”; then, this transition branch becomes such that a transition is made from state Sa to state Sc and then to state Sb.

As for the newly generated state Sc in the transition branch from state Sa to state Sb, a label La for identification of state Sc is stored in the memory so as to be correlated with state Sc. The label La has a message “Lp” in which the character string “p” representing a transition condition of the transition from state Sa to state Sc is added to a message L of a label La which is correlated with state Sa.

In item (2) of FIG. 5, the transition branch between states Sa and Sd is correlated with a regular expression “p*” which represents a transition condition. Develop the regular expression “p*”; then, this transition branch becomes such that first an epsilon transition is made from state Sa to state Se, then self-looping is performed zero or more times at state Se, and finally an epsilon transition is made from state Se to state Sd.

As for the newly generated state Se in the transition branch from state Sa to state Sd, a label Le for identification of state Se is stored in the memory so as to be correlated with state Se. The label Le has a message “Lp*” in which the character string “p*” representing self-looping at operation Se is added to a message “L” of a label La which is correlated with state Sa.

In item (3) of FIG. 5, the transition branch between states Sa and Sf is correlated with a regular expression “p|q” which represents a transition condition. Develop the regular expression “p|q”; then, this transition branch is converted into two transition branches, that is, a transition branch that is taken as a transition branch from state Sa to state Sf when a transition condition “p” has occurred and a transition branch that is taken when a transition condition “q” has occurred.

The state transition graph 400 shown in FIG. 4 can be generated by developing the regular expressions (i.e., the signal variation patterns each of which is defined by “sequence”) described in the interface specification description information D1 by using the state transition algorithms of items (1)-(3).

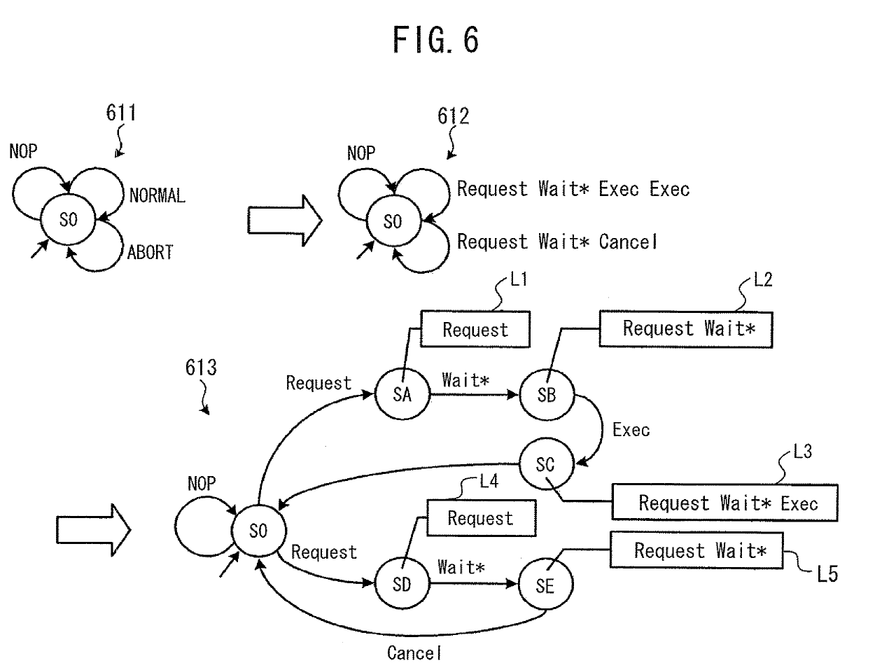

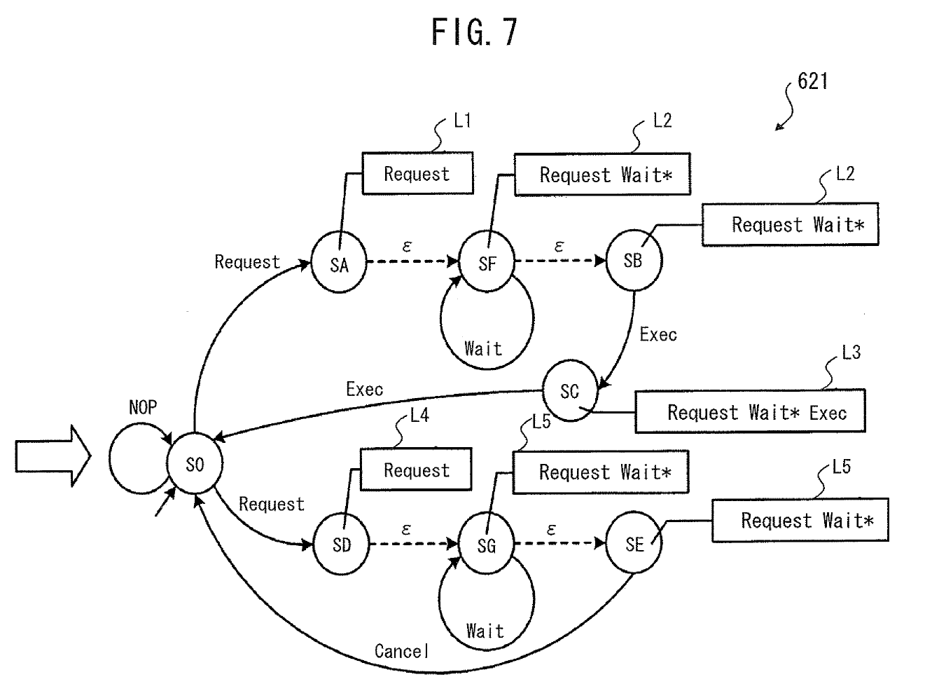

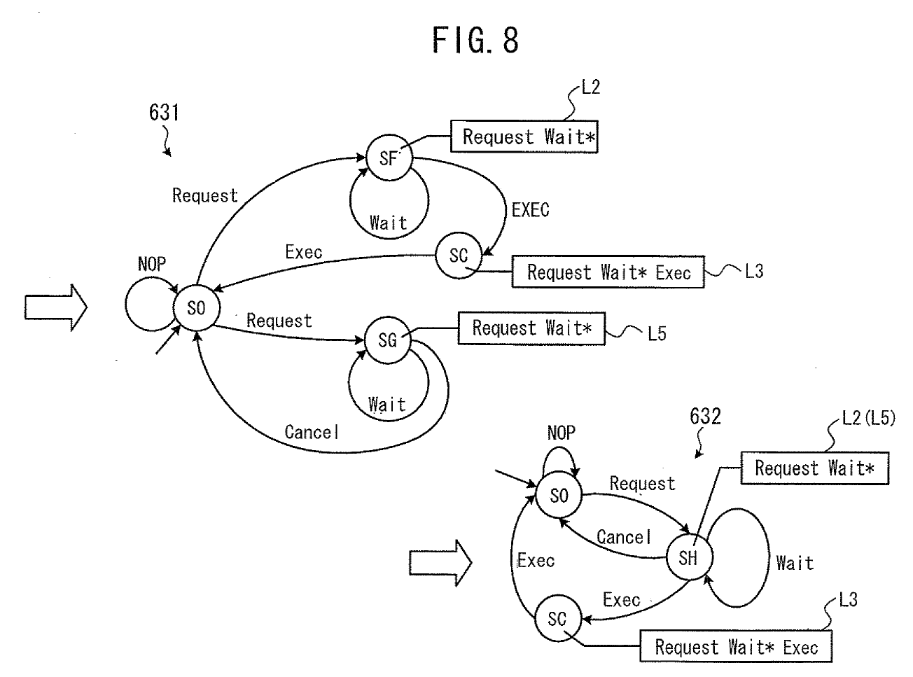

Next, a procedure for generating the state transition graph 400 on the basis of the interface specification description information D1 of FIG. 3 will be described. FIGS. 6-8 illustrate a procedure for generating the state transition graph 400. In FIGS. 6-8, state S0 is an initial state.

First, a state transition graph 611 is generated on the basis of the description of “transaction” in the interface specification description information D1 of FIG. 3. More specifically, transition branches are generated in a number (in this example, three) that is equal to the number of state sets that are defined in “transaction” and the state transition graph 611 is generated in which the generated transition branches are correlated with character strings “NOP,” “Normal,” and “Abort,” respectively.

Then, a state transition graph 612 is generated by converting the character strings “Normal” and “Abort” which are correlated with the respective transition branches on the basis of the “sequence” descriptions in the interface specification description information D1. More specifically, “Normal” is replaced by “Request Wait* Exec Exec” and “Abort” is replaced by “Request Wait* Cancel.”

Then, a state transition graph 613 is generated by developing “Request Wait* Exec Exec” and “Request Wait* Cancel” using the state transition algorithm that was described in item (1) of FIG. 5. Labels L1-L5 in which messages for identification of transition states SA-SE are written are stored in the memory so as to be correlated with the transition states SA-SE, respectively.

In the case of the label L3, for example, a sequence of character strings obtained by arranging, in order of transitions, the character strings indicating the meanings of the transition conditions of the transition branches that are taken to reach state SC starting from state S0 is written in the label L3. More specifically, a sequence of character strings “Request Wait* Exec” obtained by arranging, in order of transitions, the character strings “Request,” “Wait*,” and “Exec” that are correlated with the transition branches that are taken to reach state SC starting from state S0 is written in the label L3.

Then, a state transition graph 621 including epsilon transitions is generated by developing “Wait*” using the state transition algorithm that was described in item (2) of FIG. 5. The same label L2 as correlated with state SB is correlated with a newly generated state SF, and the same label L5 as correlated with state SE is correlated with a newly generated state SG.

Then, a state transition graph 631 is generated by simplifying and rearranging the state transition graph 621. More specifically, the state transition graph 631 is generated by eliminating the epsilon transition branches. In doing so, only state SF is left among states SA, SF, and SB. The label L2 which is correlated with state SB that occurs latest among states SA, SF, and SB is correlated with state SF. The same applies to state SG.

Subsequently, a state transition graph 632 is generated by integrating, into a single transition branch, transition branches (indeterminate branches) in the state transition graph 631 that are taken to reach two states starting from one state and are correlated with the same transition condition. In this example, the two transition branches exist that are taken to reach the respective states SF and SG starting from state S0 if “Request” is satisfied.

Therefore, these two transition branches are integrated into a single transition branch, as a result of which states SF and SG are integrated into a single state SH. One of the labels L2 and L5 is correlated with state SH.

If labels L that are correlated with two states to be integrated together have different messages, one of the labels L may be correlated with a state generated by the integration. Alternatively, a new label L in which both messages are written may be generated and correlated with a state generated by the integration.

The state transition graph 400 of FIG. 4 can be generated finally by substituting the logical expressions for the character strings that are correlated with the respective transition branches of the thus-generated state transition graph 632 and indicate the meanings of the transition conditions. States SH and SC in the state transition graph 632 correspond to the respective states S1 and S2 in the state transition graph 400.

Returning to FIG. 2, the extraction section 203 has a function of extracting the sequence of character strings obtained by arranging, in order of transitions, the character strings indicating the meanings of the transition conditions of the transition branches that are taken to reach each transition state starting from the initial state from the finite state machine model of the hardware module M which is the check subject.

More specifically, the extraction section 203 reads the finite state machine model from the memory, extracts the sequence of character strings that are correlated with each transition state from the finite state machine model, and stores them in the memory. This finite state machine model may be either the model that has been generated by the finite state machine generation section 202 or a model that is expressed by using a state transition table 900 (described later).

More specifically, the extraction section 203 extracts the sequence of character strings that is correlated with each of the transition states (i.e., states S1 and S2) in the state transition graph 400 in which the sequence of character strings obtained by arranging, according to the signal variation pattern, the character strings indicating the meanings of the input conditions of signals that are input to the hardware module M is correlated with each transition state.

The sequence of character strings is the message “Request Wait*” or “Request Wait* Exec” which is written in the label L1 or L2 which is correlated with the state S1 or S2 of the state transition graph 400.

The extraction section 203 stores the sequences of character strings in the memory in such a manner that they are correlated with the respective states S1 and S2. That is, the extraction section 203 stores the sequence of character strings “Request Wait*” of the label L1 in the memory in such a manner that it is correlated with state S1 and stores the sequence of character strings “Request Wait* Exec” of the label L2 in the memory in such a manner that it is correlated with state S2.

The generation section 204 has a function of generating message information which means transitions that are made to reach each transition state starting from the initial state by burying the sequence of character strings extracted by the extraction section 203 at a burying position for a partial character string that is part of a character string indicating each state of the finite state machine model.

More specifically, for example, the generation section 204 generates message information which means transitions that are taken to reach each transition state starting from the initial state using a message template which is used for generating a message sentence to describe the feature of each state of a finite state machine model, and stores the generated message information in the memory. The message template to be used for generating message information will be described below.

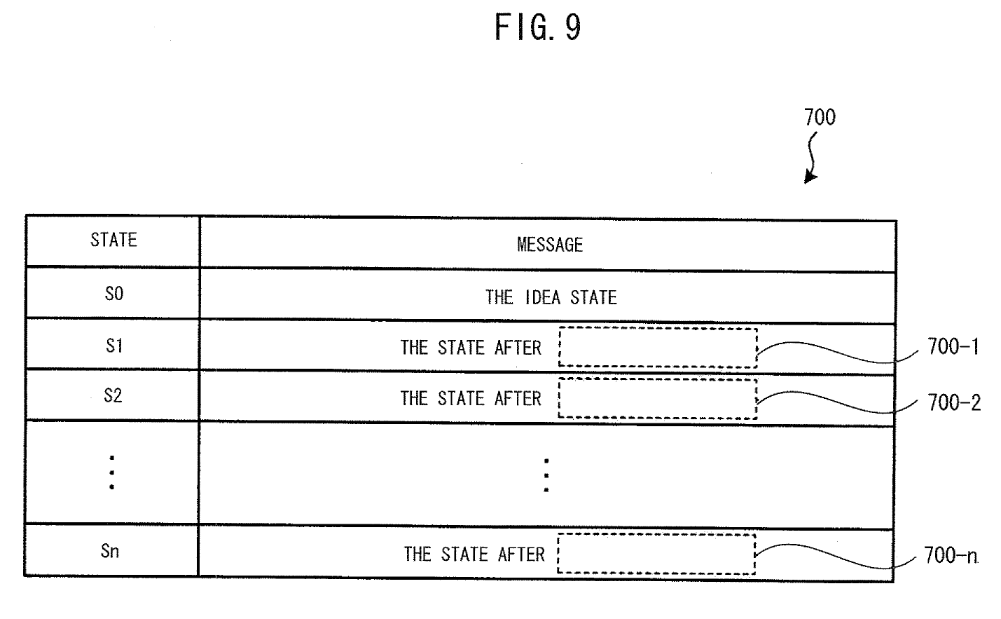

FIG. 9 illustrates an exemplary message template. In FIG. 9, a message template 700 is a template to be used for generating message sentences to describe the features of states S0-Sn of a finite state machine model. More specifically, a fixed message sentence indicating state S0 (initial state) and incomplete message sentences for the respective states S1-Sn are prepared in the message template 700.

The fixed message sentence indicating state S0 is “the idle state” which means that this state is an initial state. The incomplete message sentences for states S1-Sn are “the state after “blank” in which a blank is provided at burying positions 700-1 to 700-n for partial character strings that are parts of character strings indicating states S1-Sn, respectively.

The generation section 204 generates message information which means transitions that are taken to reach each transition state starting from the initial state by burying the sequences of character strings extracted by the extraction section 203 at the burying positions 700-1 to 700-n of the message template 700 for partial character strings that are parts of character strings indicating respective states of a finite state machine model.

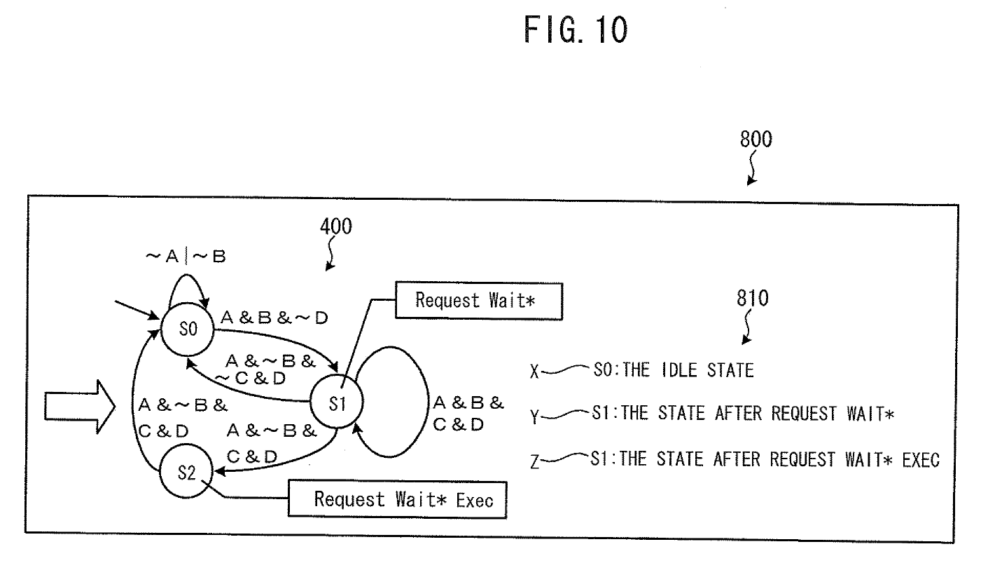

In this example, the generation section 204 can generate message information 810 (see FIG. 10) which means the transitions that are taken to reach states S1 and S2 starting from state S0 by burying “Request Wait*” and “Request Wait* Exec” which are the sequences of character strings extracted by the extraction section 203 at the corresponding burying positions 700-1 and 700-2 of the message template 700.

The output section 205 has a function of reading, from the memory, the message information 810 generated by the generation section 204 and outputting it. The output section 205 may output the state transition graph 400 in such a manner that it is correlated with the message information 810. The output form of the output section 205 may be any of screen output by the display 131, print output by the printer 1331 data output (storage) to a memory, and transmission to an external computer.

A specific example of the output form of the output section 205 will be described below. FIG. 10 illustrates a specific example of the output form in which the state transition graph 400 is output so as to be correlated with the message information 810. In FIG. 10, an output result 800 includes the state transition graph 400 of FIG. 4 and the message information 810 that has been generated by the generation section 204.

The message information 810 includes, the as message sentences that describe the features of states S0, S1, and S2 of the state transition graph 400, a message X which means that the state S0 is the initial state and messages Y and Z which mean the transitions that are taken to reach the respective states S1 and S2 starting from state S0.

The designer can intuitively recognize the transitions from state S0 to each of states S1 and S2 from the state transition graph 400 of the output result 800, and can intuitively grasp how each of states S1 and S2 is reached starting from state S0 from the description of the message information 810.

Although in this embodiment the finite state machine model is generated automatically on the basis of the interface specification description information D1, the finite state machine model may be generated manually by the designer. In this case, the designer manually generates a state transition table which shows a set of finite states that the hardware module M can take and sets of finite transitions each of which is a set of possible transitions from a certain state to other states.

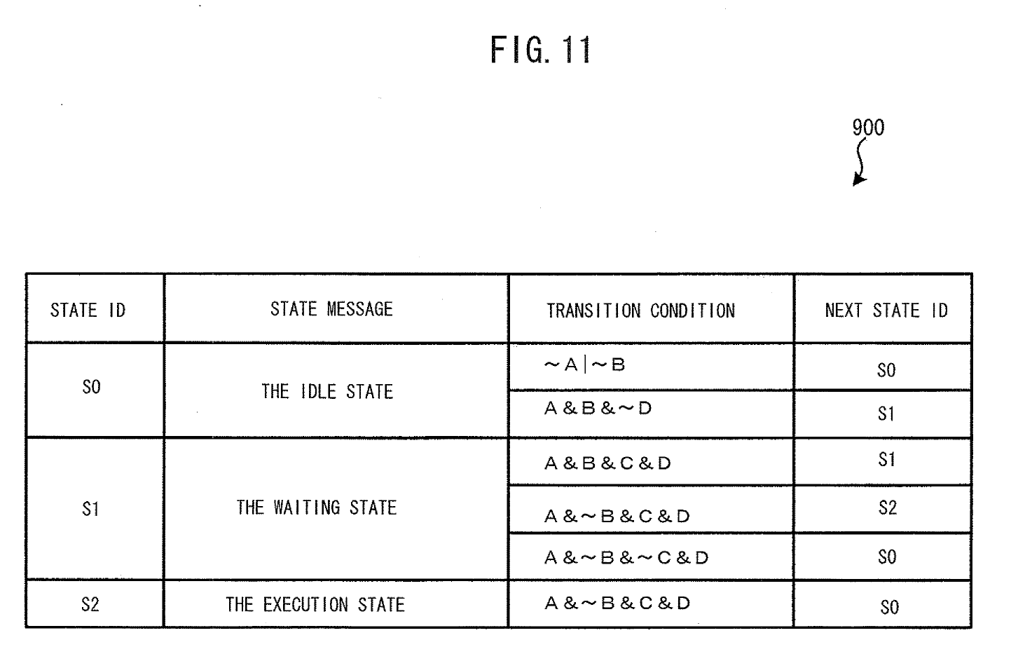

FIG. 11 illustrates a state transition table of the hardware module M. In FIG. 11, the state transition table 900 holds, for each of the respective states of the finite state machine model, a state ID, a state message, transition conditions, and information relating to next state IDs. The state ID is identification information for identification of each state.

The state messages are messages indicating the features of the respective states, and correspond to, for example, the messages X, Y, and Z shown in FIG. 10. The transition conditions are transition conditions of transition branches between states. The next state IDs are destination states of transitions that are made according to the respective transition conditions.

The finite state machine model of the hardware module M can be generated by using the state transition table 900. To generate the message information 810 on the basis of the state transition table 900, the state messages of the respective states are extracted from the state transition table 900 by the extraction section 203 and the message sentences of the message information 810 are generated by using the extracted state messages.

More specifically, the input section 201 accepts input of the state transition table 900 which expresses the finite state machine model of the hardware module M and contains the state messages that describe the feature of the respective states of the finite state machine model. The extraction section 203 extracts, as sequences of character strings, the state messages of the state transition table that has been input through the input section 201.

The message information 810 which means the transitions that are taken to reach each transition state starting from the initial state can be generated by replacing the state messages extracted by the extraction section 203 with the incomplete message sentences of the message template 700 which indicate the respective states of the finite state machine model.

Returning to FIG. 2, the acquisition section 206 has a function of acquiring, from the finite state machine model of the hardware module M, constraint logical expressions which relate to constraints that should be satisfied by signals that are input to the hardware module M. More specifically, the acquisition section 206 reads the finite state machine model from the memory, acquires constraint logical expressions for the respective states from the finite state machine model, and stores them in the memory.

Even more specifically, for example, the acquisition section 206 acquires a constraint logical expression which is the OR of the logical expressions that are correlated with the respective transition branches between each state and corresponding transition destination states of the state transition graph 400 in which the logical expressions that prescribe the transition conditions between each transition source state and corresponding transition destination states using the input variables for describing the input conditions are correlated with the respective transition branches.

For example, in the case of state S1 of the state transition graph 400 of FIG. 4, the constraint logical expression of state S1 is the OR of the logical expressions “A&˜B&˜C&D,” “A&B&C&D,” and “A&˜B&C&D” which are correlated with the respective transition branches. The constraint logical expression of state S1 is thus expressed as the following Formula (1):

(A&˜B&˜C&D)|(A&B&C&D)|(A&˜B&C&D) (1)

The assertion generation section 207 has a function of generating assertion description information D2 to be used for checking for non-satisfaction of the constraints by burying the constraint logical expressions acquired by the acquisition section 206 at subject burying positions adjacent to the predicates of report sentences indicating non-satisfaction of a constraint and burying the message information (e.g., the messages X, Y, and Z shown in FIG. 10) at burying positions for partial character strings which are parts of the predicates.

The assertion description information D2 is information for realizing assertion to be used for checking for non-satisfaction of the constraints that should be satisfied by signals that are input to the hardware module M in performing a logical check on the hardware module M. For example, the assertion description information D2 is written in PSL (Property Specification Language).

In generating assertion description information D2, Formula (1) may be buried at a subject burying position adjacent to the predicate of a report sentence which indicates non-satisfaction of the constraint. Alternatively, it is possible to decompose Formula (1) into plural logical expressions “A&˜B&˜C&D,” “A&B&C&D,” and “A&˜B&C&D” and bury them at subject burying positions.

Each report sentence in the assertion description information D2 is information that is output when a constraint comes unsatisfied. Based on the report sentence, the designer can determine where the constraint comes unsatisfied. In this embodiment, the contents of the report sentences are made more detailed to assist in quickly finding a location of occurrence of non-satisfaction of a constraint.

The output section 205 also has a function of reading, from the memory, the assertion description information D2 generated by the assertion generation section 207 and outputting it. The assertion description information D2 can be used, together with hardware description information D3 (described later), as an interface protocol checker which performs a logical check on the hardware module M.

A description will now be made of an exemplary method for generating assertion description information D2 with the assertion generation section 207. A method for generating assertion description information D2 will be described below by using, as an example, state S1 in the state transition graph 400. First, the conversion section 208 of the assertion generation section 207 decomposes the constraint logical expression into plural product terms.

More specifically, for example, the conversion section 208 decomposes the constraint logical expression into plural product terms by performing irredundant sum-of-products expression conversion on the NOTs in the constraint logical expression. The irredundant sum-of-products expression conversion will not be described because it is a known technique.

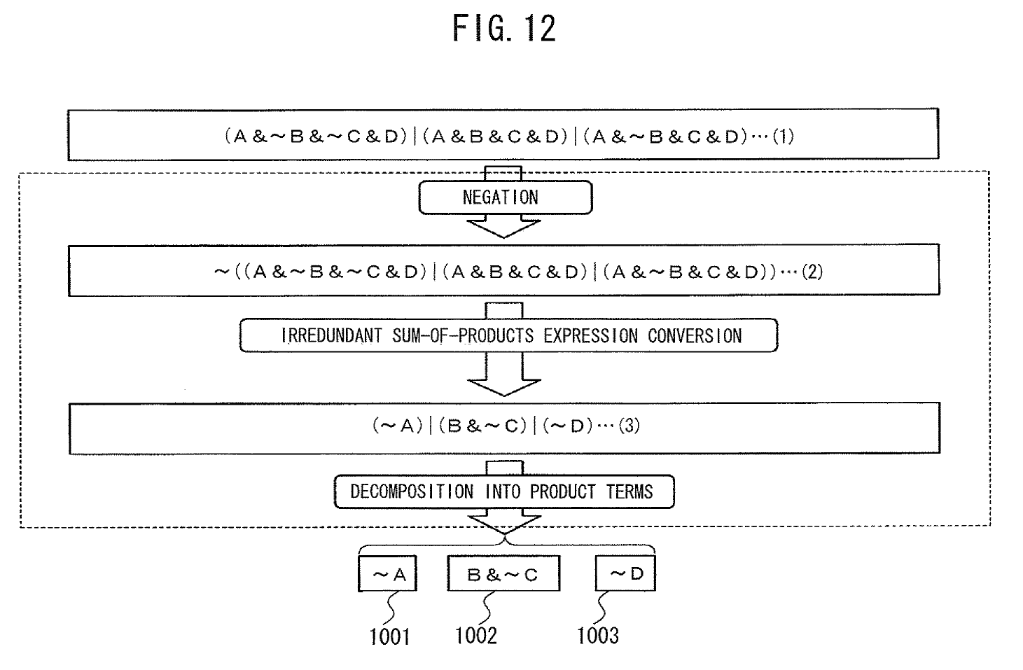

FIG. 12 illustrates the outline of a constraint logical expression conversion process. As shown in FIG. 12, first, Formula (2) is generated by negating Formula (1) that has been acquired by the acquisition section 206. Then, Formula (3) is generated by performing irredundant sum-of-products expression conversion on Formula (2) and Formula (3) is decomposed into product terms 1001-1003.

In this manner, the constraint logical expression (Formula (1)) for state S1 can be expressed in a simplified manner. More specifically, the logical expressions “A&˜B&˜C&D,” “A&B&C&D,” and “A&˜B&C&D” correspond to the respective product terms 1001-1003.

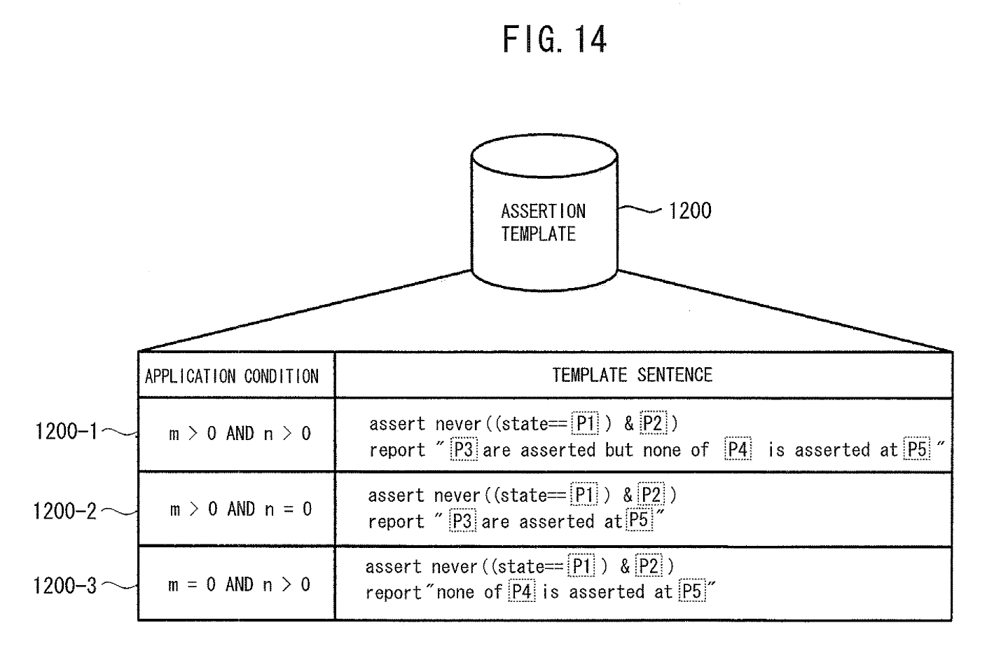

Then, the product terms 1001-1003 are applied to an assertion template (see FIG. 14), whereby assertion description information D2 to be used for checking for non-satisfaction of the constraint that should be satisfied by signals that are input to the hardware module M is generated.

In applying the product terms 1001-1003 to the assertion template, first, a variable list Rt is generated in which each of the product terms 1001-1003 is divided into variables P1, . . . , Pm that do not include “˜” which represents NOT and variables Q1, . . . , Qn that include “˜.” The variables are signal values A-D of the interface signal A-D.

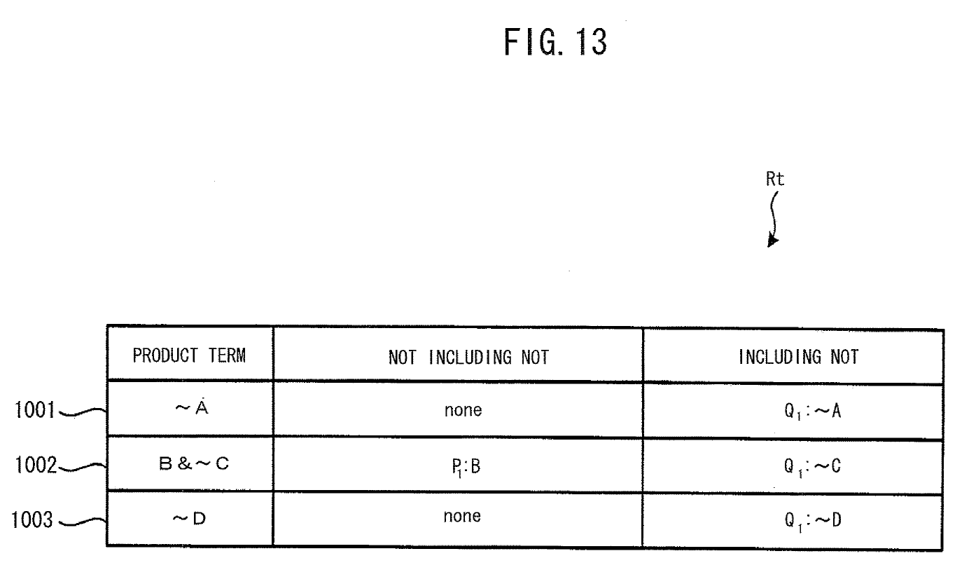

FIG. 13 illustrates a variable list Rt of state S1. As shown in FIG. 13, variables not including “˜” and variables including “˜” are held in the variable list Rt so as to be divided for each of the product terms 1001-1003. More specifically variable Q1: ˜A which includes NOT is held for the product term 1001. Variable P1: B which does not include NOT and variable Q1: ˜C which includes NOT are held for the product term 1002. Variable Q1: ˜D which includes NOT is held for the product term 1003. In FIG. 13, “none” is written in the case where no corresponding variable exists.

Then, the product terms 1001-1003 are applied to the assertion template individually using the variable list Rt. FIG. 14 illustrates an exemplary assertion template. In FIG. 14, an assertion template 1200 is a template for determining description contents of assertion description information D2.

The assertion template 1200 has, for respective application conditions, template sentences 1200-1 to 1200-3 to be written in assertion description information D2. The application conditions are conditions for determining which of the template sentences 1200-1 to 1200-3 the product terms 1001-1003 should be applied to.

Plural blanks (burying positions P1-P5) are prepared in the template sentences 1200-1 to 1200-3, and descriptions of assertion description information D2 are generated by burying proper character strings at the burying positions P1-P5. More specifically, a state name is buried at the burying position P1, a product term is buried in the burying position P2, variables not including NOT of the product term are buried in the burying position P3, variables including NOT of the product term are buried in the burying position P4, and message information corresponding to the state is buried at the burying position P5.

To apply the product terms 1001-1003 to the assertion template 1200, first, the application conditions of the respective product terms 1001-1003 are determined according to the contents of the variable list Rt. More specifically, the application condition of the product term 1001 should be “m=0 and n>0” because the product term 1001 has only variable Q1=˜A which includes NOT. The application condition of the product term 1002 should be “m>0 and n>0” because the product term 1002 has variable P1: B which does not include NOT and variable Q1: ˜C which includes NOT. The application condition of the product term 1003 should be “m=0 and n>0” because the product term 1003 has only variable Q1: ˜D which includes NOT.

Then, assertion description information D2 is generated by burying character strings at the burying positions P1-P5 of the template sentences 1200-1 to 1200-3 of the assertion template 1200 according to the application conditions of the product terms 1001-1003.

For example, in the case of the product term 1001, since the application condition is “m=0 and n>0,” proper character strings are buried at the burying positions P1-P5 of the template sentence 1200-3. More specifically, the state name “S1” is buried at the burying position P1 of the template sentence 1200-3, the product term “˜A” is buried at the burying position P2, variable “A” including NOT is buried at the burying position P4, and the message Y (see FIG. 10) corresponding to state S1 is buried at the burying position P5.

As a result, the description of the assertion description information D2 relating to the product term 1001 of state S1 is completed. Likewise, descriptions for the product terms 1002 and 1003 are completed. The assertion description information D2 is thus generated finally which includes those descriptions.

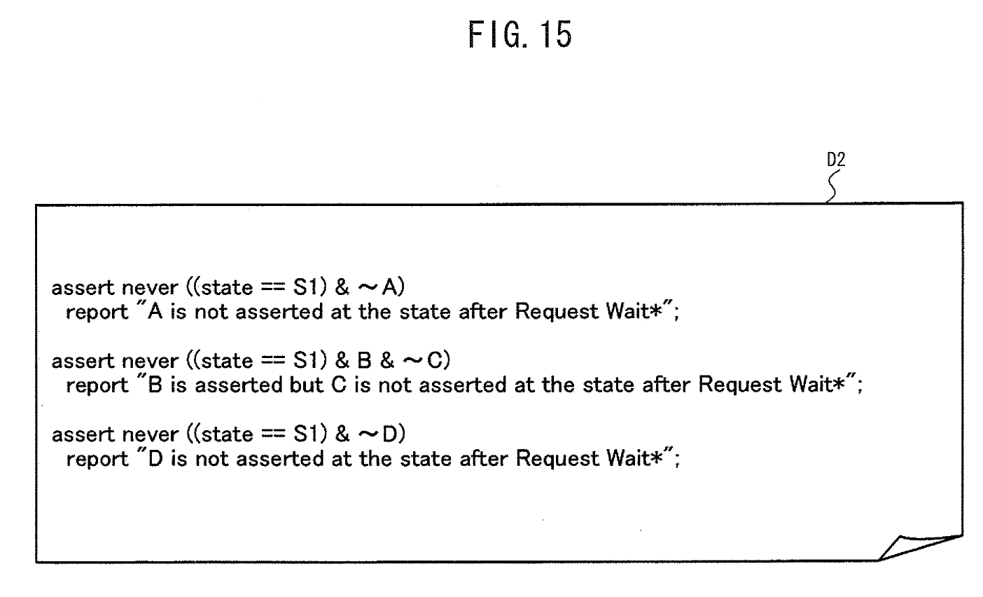

FIG. 15 illustrates the assertion description information D2 of the hardware module M. The information relating to state S1 of the state transition graph 400 is described as shown in FIG. 15 in the assertion description information D2. If any of the constraints that should be satisfied by the interface signals A-D comes unsatisfied, the report sentence that follows the word “report” and corresponds to the constraint is presented to the designer.

For example, if the constraint that should be satisfied by the interface signal A comes unsatisfied at state S1, the report sentence “A is not asserted at the state after Request Wait*” is output. The designer can quickly determine where the constraint has come unsatisfied by recognizing the report sentence using the message information 810 shown in FIG. 10.

Returning to FIG. 2, the hardware description information generation section 209 has a function of generating hardware description information D3 which shows operation of the hardware module M using the finite state machine model of the hardware module M. The hardware description information D3 is described by using a hardware description language HDL such as Verilog. Hardware description information D3 generated by the hardware description information generation section 209 is stored in the memory.

The output section 205 also has a function of reading, from the memory the hardware description information D3 generated by the hardware description information generation section 209 and outputting it. The hardware description information D3 can be used, together with the above-described assertion description information D2, as an interface protocol checker which performs a logical check on the hardware module M.

The hardware description information generation section 209 also has a function of generating an interface protocol checker HDL which is written in a hardware description language HDL on the basis of the finite state machine model of the hardware module M and the constraint logical expressions acquired by the acquisition section 206.

The interface protocol checker HDL can be used for a logical check on the hardware module M and includes the description contents of the assertion description information D2 and the hardware description information D3. More specifically, for example, the assertion description information D2 generated by using the assertion template 1200 is expressed in a hardware description language HDL.

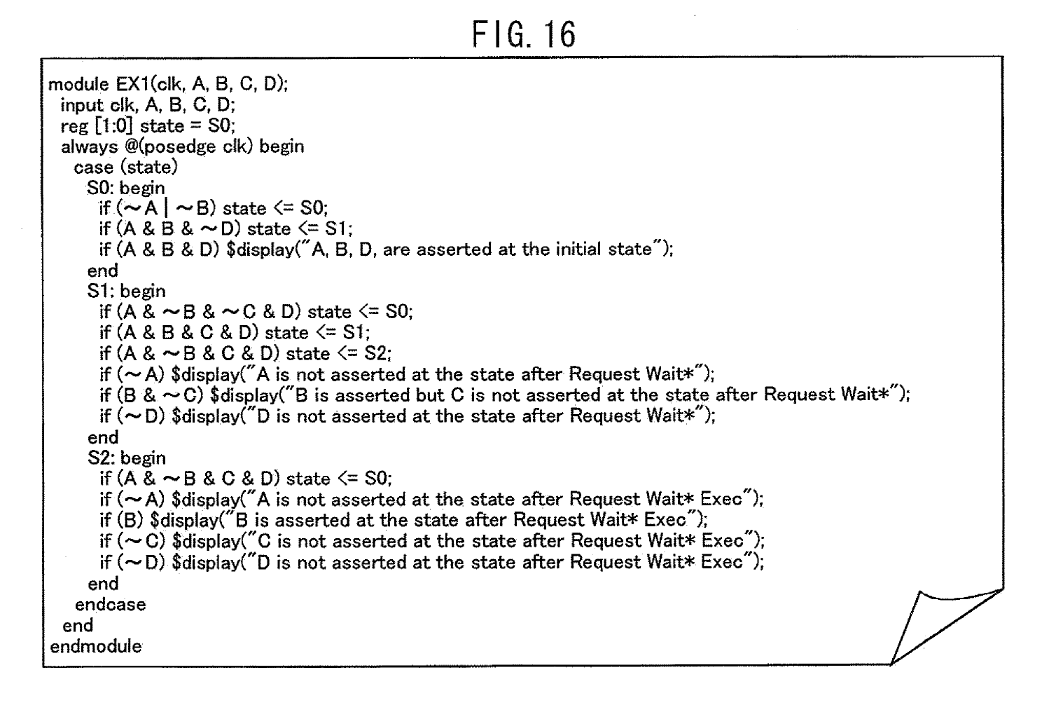

The output section 205 also has a function of outputting the interface protocol checker HDL generated by the hardware description information generation section 209. A specific example of the interface protocol checker HDL written in a hardware description language HDL will be described below. FIG. 16 illustrates a specific example of the interface protocol checker HDL.

In the interface protocol checker HDL of FIG. 16, the assertion description information D2 and the hardware description information D3 of the hardware module M are written in a hardware description language HDL. For example, the constraints that should be satisfied by the signals that are input to the hardware module M are written as if-clauses and the report sentences to be issued when the constraints come unsatisfied are written after the word “display.”

Even more specifically, for example, a report sentence that is issued when the constraint relating to the interface signal D at state S1 comes unsatisfied is “D is not asserted at the state after Request Write*.”

As a result, even in an environment in which PSL cannot be used or even if the designer does not know PSL, an interface protocol checker to be used for a logical check on a hardware module M can be generated automatically by using a hardware description language HDL.

(Logical Check Assist Process of Logical Check Assist Apparatus 100)

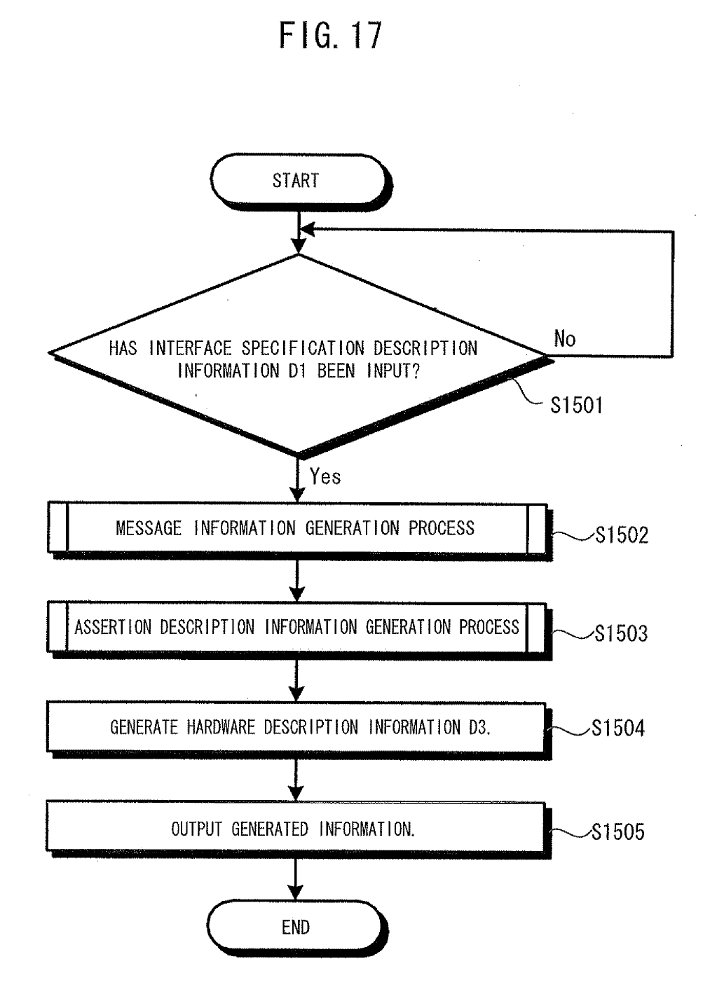

FIG. 17 is a flowchart showing a logical check assist process of the logical check assist apparatus 100 according to the embodiment of the invention.

In the flowchart of FIG. 17, first, at operation S1501, it is judged whether or not interface specification description information D1 has been input through the input section 201. If the judgment result of operation S1501 is “no,” the process waits for input of interface specification description information D1. If interface specification description information D1 is input (operation S1501: yes), the generation section 204 executes a message information generation process at operation S1502.

At operation S503, the assertion generation section 207 executes an assertion description information generation process. At operation S1504, the hardware description information generation section 209 generates hardware description information D3 which indicates operation of a hardware module M, using a finite state machine model of the hardware module M.

Finally, at operation S1505, the output section 205 outputs message information 810 that was generated at operation S1502 and outputs, as an interface protocol checker, assertion description information D2 that was generated at operation S1503 and the hardware description information D3 that was generated at operation S1504.

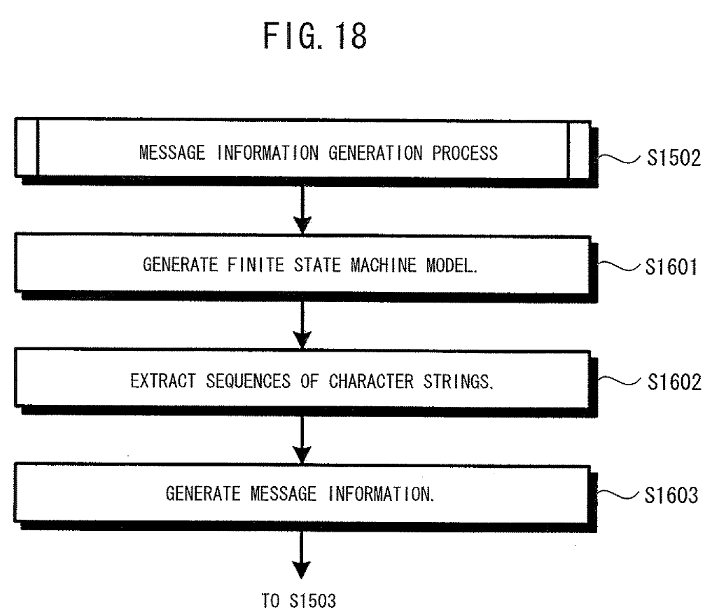

Next, a description will be made of the message information generation process (operation S1502) shown in FIG. 17. FIG. 18 is a flowchart of the message information generation process. In the flowchart of FIG. 18, first, at operation S1601, the finite state machine generation section 202 generates a finite state machine model relating to state transitions of signals that are input to and output from the hardware module M on the basis of the interface specification description information D1 that was input at operation S1501 shown in FIG. 17.

At operation S1602, the extraction section 203 extracts, from the finite state machine model generated by the finite state machine generation section 202, a sequence of character strings that are arranged in order of transitions and indicate the meanings of transition conditions of transition branches that are taken to reach each transition state starting from an initial state.

At operation S1603, the generation section 204 generates message information 810 which means the transitions that are made to reach each transition state starting from the initial state by burying the sequence of character strings extracted by the extraction section 203 at a burying position for a partial character string which is part of a character string indicating each state of the finite state model, using the message template 700. Then, the process moves to operation S1503 shown in FIG. 17.

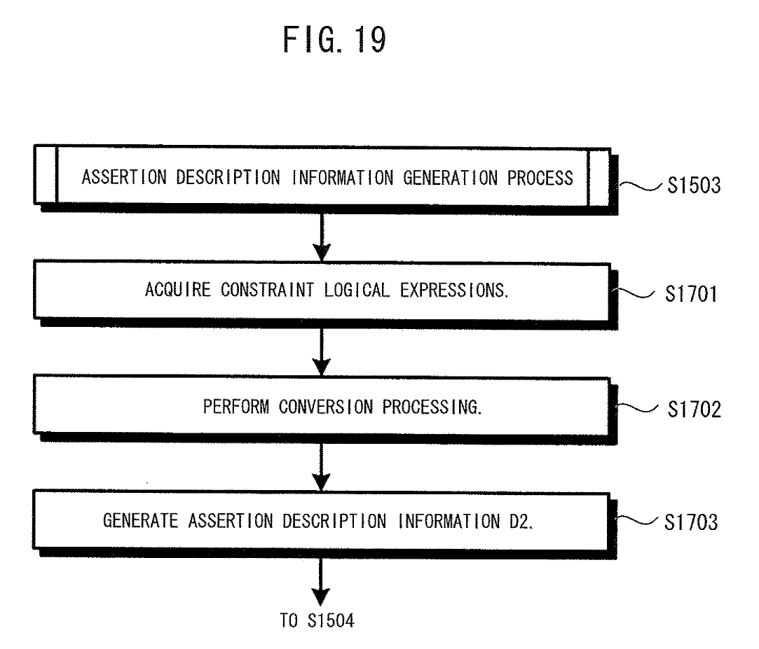

Next, a description will be made of the assertion description information generation process (operation S1503) shown in FIG. 17. FIG. 19 is a flowchart of the assertion description information generation process.

In the flowchart of FIG. 19, first, at operation S1701, the acquisition section 206 acquires, from the finite state machine model that was generated at operation S1601 (see FIG. 18), constraint logical expressions relating to restrictions that should be satisfied by signals that are input to the hardware module M.

At operation S1702, the conversion section 208 performs conversion processing of converting the constraint logical expressions acquired by the acquisition section 206 into product terms. At operation S1703, the assertion generation section 207 generates assertion description information D2 to be used for checking for non-satisfaction of the constraints by burying the product terms converted by the conversion section 208 at the subject burying positions adjacent to the predicates of the report sentences indicating non-satisfaction of the constraints and burying the message information 810 that was generated at operation S11502 (see FIG. 17) at the burying positions for partial character strings which are parts of the predicates, using the assertion template 1200. Then, the process moves to operation S1504 shown in FIG. 17.

As described above, according to the embodiment, message information 810 which describes features of respective states can be generated automatically by using a finite state machine model of a hardware module M. And message information 810 that the designer can understand easily can be generated automatically by describing message sentences which indicate features of respective states using character strings indicating the meanings of input conditions for signals that are input to the hardware module M.

The designer can easily identify the states by recognizing the contents of the message information 810. Furthermore, since a message that is correlated with an associated piece of message information 810 and indicates the feature of a state is included in a report sentence that is presented to the designer when a constraint comes unsatisfied, the designer can easily determine where (and when) the constraint came unsatisfied.

As described above, the logical check assist program, the recording medium on which the program is recorded, the logical check assist apparatus, and the logical check assist method according to the invention can shorten the logical check period by presenting, to the designer, error messages that the designer can understand easily.

The logical check assist method according to the embodiment can be realized by causing a computer such as a personal computer or a workstation to run a program that is prepared in advance. This program is recorded on computer-readable recording medium such as a hard disk, a flexible disk, a CD-ROM, an MO, or a DVD and is run by reading it from the recording medium with the computer. Alternatively, this program may be distributed over a transmission medium such as a network (e.g., the Internet).

The logical check assist apparatus 100 according to the embodiment can be implemented as an ASIC (application-specific integrated circuit) such as a standard cell or a structured ASIC or a PLD (programmable logic device) such as an FPGA. More specifically, for example, the logical check assist apparatus 100 can be manufactured by defining the functions of its function blocks 201-209 as HDL descriptions and giving an ASIC or a PLD a result of logic synthesis that is performed on the basis of the HDL descriptions.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A computer readable recording medium storing a program, said program, when executed by a computer, causing the computer to execute the functions comprising:
extracting a sequence of character strings that are arranged in order of transitions and indicate meanings of transition conditions of transition branches that are taken to reach each transition state starting from an initial state from a finite state machine model of a hardware module which is a check subject;
generating message information which means transitions that are taken to reach each transition state starting from the initial state by burying the sequence of character strings extracted at a burying position for a partial character string which is part of a character string indicating each state of the finite state machine model; and
outputting the message information.

2. The computer readable recording medium of claim 1, wherein the functions further comprise:
acquiring, from the finite state machine model, constraint logical expressions relating to constraints that should be satisfied by signals that are input to the hardware module; and
generating assertion description information to be used for checking for non-satisfaction of the constraints by burying the constraint logical expressions acquired at subject burying positions adjacent to predicates of report sentences which indicate non-satisfaction of the constraints and burying the message information at burying positions for partial character strings that are parts of the predicates.

3. The computer readable recording medium of claim 2, wherein the assertion description information is generated by burying signal names of the signals that are input to the hardware module at the subject burying positions, the signal names being included in the constraint logical expressions, and burying the message information at the burying positions for the partial character strings.

4. The computer readable recording medium of claim 1, wherein the functions further comprise:
accepting input of interface specification description information relating to a communication procedure of the hardware module; and
generating a finite state machine model relating to state transitions of signals that are input to and output from the hardware module on the basis of the interface specification description information, and
wherein the sequences of character strings are extracted from the finite state machine model.

5. The computer readable recording medium of claim 4, wherein:
the interface specification description information includes character strings indicating meanings of input conditions for signals that are input to the hardware module and signal variation patterns of the signals;
the finite state machine model is expressed as a state transition graph in which a sequence of character strings obtained by arranging the character strings indicating the meanings of the input conditions according to the signal variation pattern is correlated with each transition state; and
the sequence of character strings that are extracted are correlated with each transition state of the state transition graph.

6. The computer readable recording medium of claim 5, wherein the finite state machine model is expressed as a state transition graph in which a logical expression that prescribes a transition condition of a transition from an arbitrary transition source state to a corresponding transition destination state using input variables for describing the input conditions is correlated with each transition branch, and
wherein the functions further comprise acquiring a constraint logical expression that is the OR of logical expressions that are correlated with transition branches between each state and a corresponding transition destination state in the state transition graph.

7. The computer readable recording medium of claim 6, wherein the state transition graph is output in such a manner that it is correlated with the message information.

8. The computer readable recording medium of claim 4, wherein:
input of a state transition table is accepted which expresses the finite state machine model and contains state message information that indicates features of the respective states of the finite state machine model; and
the state message information of the state transition table is extracted as the sequences of character strings.

9. The computer readable recording medium of claim 1, wherein the functions further comprise generating hardware description information which indicates operation of the hardware module using the finite state machine model.

10. A logical check assist apparatus comprising:
an extracting section to extract a sequence of character strings that are arranged in order of transitions and indicate meanings of transition conditions of transition branches that are taken to reach each transition state starting from an initial state from a finite state machine model of a hardware module which is a check subject;
a generating section to generate message information which means transitions that are taken to reach each transition state starting from the initial state by burying the sequence of character strings extracted by the extracting section at a burying position for a partial character string which is part of a character string indicating each state of the finite state machine model; and
an output section to output the message information generated by the generating section.

11. The logical check assist apparatus of claim 10, further comprising:
an acquiring section to acquire, from the finite state machine model, constraint logical expressions relating to constraints that should be satisfied by signals that are input to the hardware module; and
an assertion generating section to generate assertion description information to be used for checking for non-satisfaction of the constraints by burying the constraint logical expressions acquired by the acquiring section at subject burying positions adjacent to predicates of report sentences which indicate non-satisfaction of the constraints and burying the message information at burying positions for partial character strings that are parts of the predicates.

12. The logical check assist apparatus according to claim 11, wherein the assertion generating section generates the assertion description information by burying signal names of the signals that are input to the hardware module at the subject burying positions, the signal names being included in the constraint logical expressions, and burying the message information at the burying positions for the partial character strings.

13. The logical check assist apparatus according to claim 10, further comprising:
an input section to accept input of interface specification description information relating to a communication procedure of the hardware module; and
a finite state machine generating section to generate a finite state machine model relating to state transitions of signals that are input to and output from the hardware module on the basis of the interface specification description information that is input-accepted by the input section,
wherein the extracting section extracts the sequences of character strings from the finite state machine model generated by the finite state machine generating section.

14. The logical check assist apparatus according to claim 13, wherein:
the interface specification description information includes character strings indicating meanings of input conditions for signals that are input to the hardware module and signal variation patterns of the signals;
the finite state machine model is expressed as a state transition graph in which a sequence of character strings obtained by arranging the character strings indicating the meanings of the input conditions according to the signal variation pattern is correlated with each transition state; and
the extracting section extracts the sequence of character strings that is correlated with each transition state of the state transition graph.

15. The logical check assist apparatus according to claim 14, wherein the finite state machine model is expressed as a state transition graph in which a logical expression that prescribes a transition condition of a transition from an arbitrary transition source state to a corresponding transition destination state using input variables for describing the input conditions is correlated with each transition branch, and
wherein the logical check assist apparatus further comprises acquiring section to acquire a constraint logical expression that is the OR of logical expressions that are correlated with transition branches between each state and a corresponding transition destination state in the state transition graph.

16. The logical check assist apparatus according to claim 14, wherein the output section outputs the state transition graph in such a manner that it is correlated with the message information.

17. The logical check assist apparatus according to claim 13, wherein:
the input section accepts input of a state transition table which expresses the finite state machine model and contains state message information that indicates features of the respective states of the finite state machine model; and
the extracting section extracts, as the sequences of character strings, the state message information of the state transition table that is input-accepted by the input section.

18. The logical check assist apparatus according to claim 10, further comprising hardware description information generation section to generate hardware description information which indicates operation of the hardware module using the finite state machine model.

19. A logical check assist method comprising:
extracting a sequence of character strings that are arranged in order of transitions and indicate meanings of transition conditions of transition branches that are taken to reach each transition state starting from an initial state from a finite state machine model of a hardware module which is a check subject;
generating message information which means transitions that are taken to reach each transition state starting from the initial state by burying the sequence of character strings at a burying position for a partial character string which is part of a character string indicating each state of the finite state machine model; and
outputting the message information.

20. The logical check assist method according to claim 19, further comprising:
acquiring, from the finite state machine model, constraint logical expressions relating to constraints that should be satisfied by signals that are input to the hardware module; and
generating assertion description information to be used for checking for non-satisfaction of the constraints by burying the constraint logical expressions at subject burying positions adjacent to predicates of report sentences which indicate non-satisfaction of the constraints and burying the message information at burying positions for partial character strings that are parts of the predicates.
